(19) United States
(12) Patent Application Publication
(10) Pub. No.: US 2017/0046313 A1
(43) Pub. Date: Feb. 16, 2017

(54) Parsing and Interpretation of Math Problems in Multiple Choice Forms

(71) Applicant: XIAOHUA YI, Superior, CO (US)

(72) Inventor: XIAOHUA YI, Superior, CO (US)

(21) Appl. No.: 14/827,111

(22) Filed: Aug. 14, 2015

(51) Int. Cl. G06F 17/21; G06F 17/28; G06F 17/17

(52) U.S. Cl. CPC G06F 17/215; G06F 17/17; G06F 17/2854; G06F 17/28

(57) ABSTRACT

Methods, systems, and devices are described that enable the parsing and interpretation of common types of math problems in multiple choice format that are found in math textbooks and standardized tests.

### BACKGROUND

Owing to its advantage in objectivity and the low-cost in administration and grading, multiple-choice is one of the most widely used forms of problems in math tests and standardized tests, such as AP Calculus and SAT. It has been used in traditional brick-and-mortar education institutions as well as alternative forms of education such as massively-online-open-courses (MOOC), which continue to gain traction in recent years. As a matter of fact, MOOC uses almost exclusively the multiple-choice format in quizzes and exams due to the overwhelmingly large students/teachers ratio.

Multiple choice format does have certain drawbacks. Among there are (i) a test taker cannot get partial credit although she may have partial mastering of the subject being tested in a problem; (ii) a test taker can game a test by guessing answers; and (iii) the format is believed by education experts not adequate for evaluating test takers' higher cognitive skills such as problem-solving and reasoning.

### SUMMARY

The present disclosure generally relates to one or more improved systems, methods, and/or apparatuses for parsing and interpretation of multiple choice problems. Aspects disclosed herein provide entering and capturing common patterns of multiple choice problems into a computer language and methods for solving the problems accordingly, including providing detailed explanations and reasoning for the solutions. Furthermore, in some aspects, techniques are provided for resolving context sensitivity of symbolic expression using tags. Various aspects provide multiple choice problem solutions using a hybrid language that mixes natural language and symbolic expressions with syntax that greatly resembles mathematical notations.

### BRIEF DESCRIPTION OF THE DRAWINGS

FIG. 1 illustrates an abstract-syntax-tree (AST) of various examples of the present disclosure;

FIG. 2 is a screenshot of an example query pattern of the present disclosure;

FIG. 3 is a screenshot of an example output of the present disclosure;

FIG. 4 is a screenshot of the output of a nested FOL function of an example of the present disclosure;

FIG. 5 is a block diagram of a domain language for a subject on top of a common mathematical language according to some examples of the present disclosure;

FIG. 6 is a screenshot of an example of a free-response problem according to some examples of the present disclosure;

FIG. 7 is a screenshot of another example of a free-response problem according to some examples of the present disclosure;

FIG. 8 is a block diagram of an exemplary system according to some examples of the present disclosure; and

FIG. 9 is a block diagram of an exemplary computing network according to some examples of the present disclosure.

### DETAILED DESCRIPTIONS

As mentioned above, various aspects of the present disclosure enable parsing and interpretation of multiple choice problems. This is achieved by expanding Leibniz language—a hybrid language that mixes simple English with mathematical expressions that is described in more detail in U.S. Pat. No. 8,943,113, which is incorporated herein by reference in its entirety. Leibniz is an interpretative language designed for mathematical applications. It is a hybrid language that mixes natural language and symbolic expressions with syntax that greatly resembles mathematical notations.

The addition of the ability to parse and interpret some of the common types of multiple choice math problems that appear in homework problems in math textbooks and standard tests into the Leibniz language, along with its capability of composing narratives that explain the problem solving process similar to the solutions made by teachers, the language is pedagogically powerful and particularly suited for applications in math education.

A multiple choice problem typically consists two parts: stem and options. The stem sets up the problem by stating explicitly facts and assumptions if any, and the options provide a set of possible expressions that can complete the last statement of the stem, or statements that can answer the query ending the stem.

The basic requirement (syntax) that a multiple-choice problem should obey is as follows: the statement formed by replacing the corresponding part in the stem by any option of the given options should be grammatically correct.

This section first discusses the extension of the language on symbolic expressions. Discussion then moves to expansion of the language on hybrid statements including tag-content construct, query patterns, and compound statements. Finally techniques are discussed for how these extensions are used jointly to define and solve multiple choice problems.

### Symbolic Expressions

Common Set Operators

Set is a fundamental concept in mathematics, and Leibniz enables defining set with a syntax that mimics the universally adopted “list notation” and “set-builder notation.” However, prior techniques have only included the “set membership” operator (using ASCII character “{”) in the language, and aspects of the present disclosure expand the list to include all common set operators using only ASCII characters as summarized in the following Table 1:

TABLE 1

| Operator | Natural Notation | Meaning |
|---|---|---|
| [ | ⊂ | subset |
| [= | [symbol] | subset or equal |
| ] | ⊃ | superset |
| ]= | [symbol] | superset or equal |
| ][ | ∩ | intersection |
| [ ] | ∪ | union (inclusive) |
| \ | \ | difference |
| * | x | Cartesian product |

The ASCII representation of subset and superset operators ([, [=, ], ]=) can be considered as asciilization of their representations in natural notation (⊂, ⊂, ⊃, and ⊃) based on glyph (visual) similarity and the meaning of the identical operator(=).

The choice of “][” is based on the observation that the intersection operator will result in a set that is subset to both starting sets being considered. So if A, B are the starting sets, and C is the set resulted for intersecting, it must be true that

A]C [symbol] C[B],

which suggests us to express this process as A][B. Notice that we have assigned higher precedence to “][” than “[],” which is required by the ANSI standard.

“@” as Substitution Operator

In many occasions, a notation is needed to represent evaluating an expression subject to a particular constraint such as a derivative evaluated at given values of independent variables (in Taylor expansion for instance). In general this type of operation can be considered as sequential substitutions. One option of representing these operations is to use Church's lambda-notation applicable to logical “terms” (predicates and functions) and extend it to expressions. Leibniz chooses to use ‘@’ as an operator to represent the substitution. For instance, the first order derivative of function f with respect to x at x=0 is represented by

(d/dx)f(x)@(x=0)

It should be noted that the “@” operator is given lower precedence than the Leibniz diff op (d/dx) such that the derivative will be evaluated symbolically before the substitution is performed. Notice that the @ operator has been used to define the integration bound and index range for summation, as well as introducing the approaching clause in the limit definition previously in the language.

### Tag-Content Construct

Context sensitivity exists in mathematical language just like in natural language. One particular type of context sensitivity that involves mathematical operators can be resolved through the context, i.e. its operands.

However, context sensitivity also exists in symbolic expressions. For instance, expression “(a, b)” can mean several things: it could mean an open interval for a variable as in the assertion “f is differentiable in (a, b);”, or the coordinate 2D point as in the assertion “the coordinate of P is (x,y);”, or a row of a matrix or a vector, as in

“A=((a_0, a_1),

(b_0, b_1));”

Natural math language avoids that difficulty through the usage of tag—an explanatory string placed right before the expression that can be potentially context sensitive. For the case of “(a, b)”, the tag string can be “open interval” or “vector”, etc. In various aspects, this structure is into the Leibniz language and is named “tag-content construct.” Similar to the “set notation”, this easy-to-use construct is shown to have significantly enhanced the expressive power of the language.

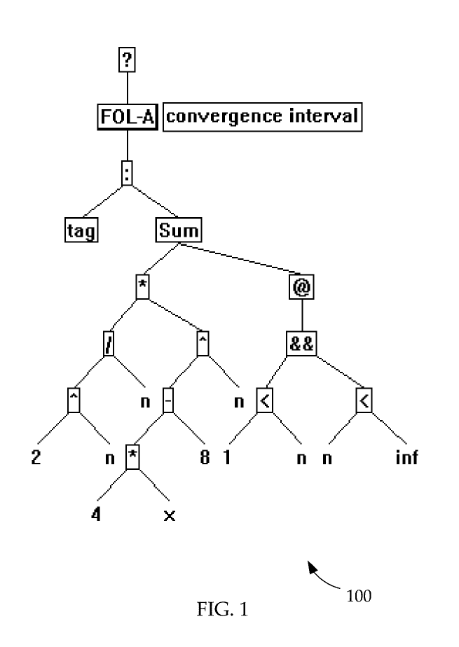

FIG. 1 illustrates an abstract-syntax-tree (AST) 100 representing the query “what is the convergence interval of the series Sum((2̂n/n)*(4*x−8)̂n)@(1<=n<inf)?”, in which the tag “series” is used to describe the intended interpretation for the expression “Sum((2̂n/n)*(4*x−8)̂n)@(1<=n<inf)”. “FOL-A” in the AST denote a function of First-Order-Logic (FOL) as discussed in co-pending application Ser. No. 14/827,106, entitled “PARSING OF LOGICAL STATEMENTS” and filed on even date herewith, the entire disclosure of which is incorporated herein by reference.

As can be seen, the construct uses colon (‘:’) as its root operator with a tag and an expression being the left and right operands of the colon operator. During interpretation, the exact meaning of the expression is determined through the tag and the expression, and the resulted entity is propagated upward to the colon operator as the semantic record it carries. Some simpler tag-content construct that involves a single symbol with a type tag such as “function f . . . ” is treated as a declaration and processed during semantic checking.

Leibniz allows the content of the tag-content to be an equation but the tag to refer the left hand side of the equation, although some mathematicians think such usage is inappropriate grammatically (see for example http://mathematics-in-europe.eu/home/65-mathhelp/mathematics-in-foreign-languages/128-how-to-write-mathematical-english). As explained by David Kramer in the article, adequate mathematical writing treats embedded symbolic expression as a single unit when it is referred in a sentence. To avoid confusion, some examples treat the symbol on the left side of the equation as the content described by the tag string, whereas the right hand side of the equation defines how the symbol is to be computed or related to other variables. Below is an example:

“if v(r)=cosh(pi*(r/R)), what is the average flow rate Q=($(v(r)*2*pi*r)dr@(0<=r<=R))/(pi*R̂2)?”

### Hybrid Statements

Query Patterns

Incorporating queries into a math language is vitally important for educational applications, since without them, students will not be able to post questions to computer software like they normally do with humans such as teachers and tutors. Also, queries are essential for defining math problems in both multiple choice and free response forms.

The Leibniz language explicitly includes a “Be-query”—queries that start with “be” (either “is” or “are”). They can be formed simply from the three types of assertions by moving the “be” word into the beginning of the sentence without changing the relative positions of the rest of the constituents. These queries can be used to question the characteristics of a single math entity such as a function, for instance, “is f differentiable at x=x_0?” They can also be used to question the relationship between two or more math entities. For example, for vectors A, B, and C, one can ask “are A, B, C linearly independent?”.

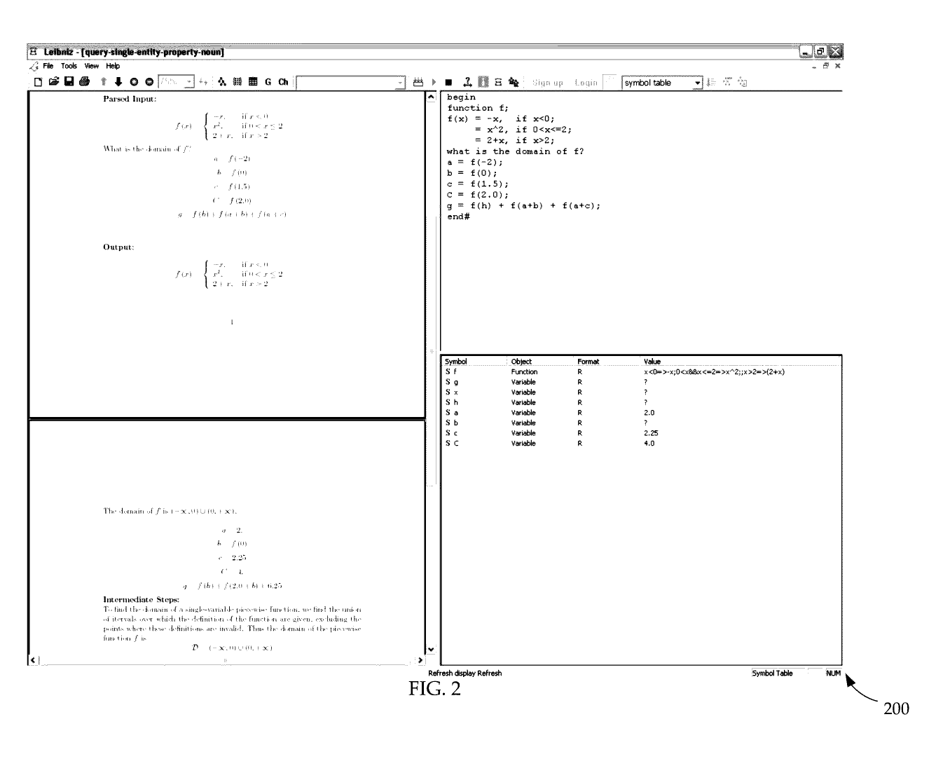

Various aspects of the disclosure have added several additional common query patterns used in defining math problems into the Leibniz language, including:
a) What-query. i.e. queries started with interrogative pronoun “what”, which can be used to query the property of a single math entity or the property collectively defined by multiple math entities. For example, for a curve C, one can ask “what is the slope of C at x=1?” Or for a plane P and a point A in 3D, one can ask “what is the distance between P and A?” (assuming that the order in which the entities appear does not matter if the entities are separated by comma or connected by “and”). A screenshot 200 for an example using this query pattern is given in FIG. 2. The example involves querying the domain of a piecewise function. Note the syntax for defining the piecewise function is natural and clear.
b) Which-query. i.e. queries started with interrogative determiner “which”. They are used for queries aimed at finding a particular option or options among a given set of such options according to the criteria specified within the query. For example, “which of the following expressions is a general solution to the differential equation ((d/dx)̂2+2*x*(d/dx))f(x)=exp(x)?”. This pattern is by far the most common query pattern found in multiple-choice problems.
c) How-to-query. This type of queries asks about the procedures used to perform a particular task. The task can be specific, namely, a detailed context is given for the task. For example,

“how to diagonalize A=((3, −3, 2),

( 0, 2, 1),

(−1, 1, ½))?”
Or the task can be general, such as “how to diagonalize a square matrix?” This type of questions rarely appear in free-response or multiple-choice problems directly, but they are commonly asked when students go to a teacher or tutor for help. Such a problem may be stated alternatively as a “command”. For instance, for the specific “how-to-query” example given above, one may replace it with the following command:

“diagonalize A=((3, -3, 2),

(0, 2, 1),

(−1, 1, ½));”
It is worthwhile to point out that the emphasis of the query and the command is different; the query is more about the procedure, whereas the command is more about the results obtained from such procedure.
d) At-what(which)-query. These type of queries ask the specific condition that will satisfy the criteria specified in the query. For example, “at what values of x is the series Sum(n*(x−3)̂n/2̂n)@(0<=n<inf)convergent?” Other prepositions such as “for” or “in” instead of “at” may be used to start this type of query.
Note that a tag string “series” is used preceding the symbolic expression “Sum(n*(x−3)̂n/2̂n)@(021 =n<inf),” which strictly speaking represents a summation of infinite number of terms instead of an infinite series that by definition is a sequence. This is a powerful syntactic construct commonly used in mathematical writing that helps to resolve ambiguities associated with mathematical expressions.

Simple and strictly structured as the patterns may appear, they abstract the structures of some of the most common questions appeared in exercises in textbooks, and standardized tests such as AP Calculus and GRE Math. Being able to recognize these common query patterns and answers them further increase the pedagogical value of the Leibniz language—they not only enable students to ask questions in these patterns, but also allow teachers to write exams and quizzes using these patterns with programily replaceable math entities thus make it more difficult for students to cheat when taking the exams and quizzes.

### Formation of Compound Statements

Compound statements, i.e. statements that are formed by combining multiple statements are very common in mathematical language. Indeed, they are the primary forms to express the logical connections between statements, including:
conjunctions ( [symbol] )that are frequently associated with (1) coordinating conjunctions such as “and”, “but”, “yet”, and “whereas”; (2) adverb (conjunctive) such as “however”, “furthermore”; and (3) correlative conjunctions including “both . . . and . . . “,” not only . . . , but also . . . ”;
disjunctions ( [symbol] ) that are normally associated with coordinating conjunction “or”;
implications ( [symbol] )that are normally associated with (1) subordinating conjunctions such as “if”, “whenever”, “unless”; (2) verb “imply”; (3) conjunctive adverbs such as “therefore”, “consequently”; and (4) phrase structure “if . . . , then . . . ”;
bi-conditional [symbol] that are normally associated with (1) phrase “. . . if and only if . . . ” that is frequently abbreviated as “iff”; and (2) verb “means”.

Based on the syntactic structures used in forming the compound statements, one may divide them into 3 categories: (1) single word or operator joining 2 statements; (2) a phrase structure with a comma (‘,’) separating the two statements connected; and (3) a single word such as a conjunctive adverb or a phrase inserted after a delimited statement with sentence-ending punctuation such as a period (‘,’) or a semicolon (‘;’) to serves as a statement connective (the first letter of the adverb is capitalized if period (‘.’) is used as delimiter; no capitalization is necessary if semicolon (‘;’) is used as delimiter. For both cases, a comma is normally placed after the adverb). All three categories have been incorporated into the grammar of the Leibniz language. More detailed explanations about each category are discussed below.

Single word or phrase. Table 2 below summarizes the syntax and their logical meaning. Notice that p and q in the table represent complete assertions.

TABLE 2

| Syntax | Logical Meaning |
|---|---|
| p “and\|but\|yet” q | p [symbol] q |
| p “or” q | p [symbol] q |
| p “implies” q | p [symbol] q |
| q “if” p | p [symbol] q |
| q “unless” p | p [symbol] [symbol] q |
| q “if and only if” p | p [symbol] q |
| q “iff\|means” p | p [symbol] q |

Note that the grammar is recursive thus statement like (p [symbol] q) [symbol] k can be derived.

Phrase structure with comma. This structure is mostly associated with the formation of implications. The following three compound statements are included in the Leibniz grammar:

- if <antecedent>, then <consequent> ”.|;”
- if <condition>, <query> ’?’
- if <condition>, <command> ”.|;”

In the above grammar rules, non-terminal grammar symbols <antecedent>, <consequent>, and <condition>are all statements of type <assertion>, i.e.

<assertion>→<antecedent>|<consequent>|<condition>, and

they all return a Boolean results when interpreted. However, that is not the case for <query>, which may return one or more math entities or a Boolean flag depending on the type of queries after interpretation.

Statement connective. That connective is normally a word or a propositional phrase following a delimited statement that is ended with period (‘.’) or semicolon (‘;’) with or without a comma (‘,’) placed afterwards. The grammar rule is simply

<statement connective> -> “conjunctive adverb”| “conjunctive
adverb”‘,’| “subordinating conjunction”

For example, a connective can be “therefore,”, “consequently,”, “however,” or simply “where” without a comma, which is commonly used to introduce a nomenclature clause in mathematical writing, e.g. “where v is the volume formed by rotating curve C about the x-axis from t=0 to t=2;”.

Examples usage of compound statements in the definition of multiple choice problems will be discussed in the following sub-section.

### Multiple Choice and Free-Response Problems

The purposes of the expansions in both symbolic expressions and hybrid statements, which are discussed above, is to further enhance the expressive power of the language so that it can be used to define mathematical problems (and other types of problems, such as physics problems) with syntax that closely resembles their definitions in natural mathematics language. The application of the language features in defining and solving both multiple-choice and free-response problems commonly found in exams and standardized tests are discussed below.

### Multiple-Choice Problems

A simple scheme of classifying multiple-choices problems can be based on how the last statement in the stem engages the options, which is usually a labeled list (the common label formats are (1) an English letter enclosed by parenthesis such as “(A)”; (2) a Roman letter followed by a period such as “II”) of expressions or statements. Before the last statement, it may or may not have other statements—simple or compound, but these statements do not impact the classification of the multiple-choice problems.

The first type is Query. Namely, the last statement of the stem is a query such as any of those discussed in 3.3.1. An example (Example 1) is listed below:
1. which of the following expressions are antiderivatives of (ln(x))̂2/x!
I. (ln(x)̂3/3
II. (ln(x))̂3/3+6
III. (2*ln(x)−(ln(x))̂2)/x̂2
(A) I
(B) III
(C) I,II
(D) I,III
(E) II,III
   Notice that this problems is a multiple-choices problem with potentially multiple answers, thus two option lists are used. The first list gives the possible options, and the second lists the possible combinations of options.

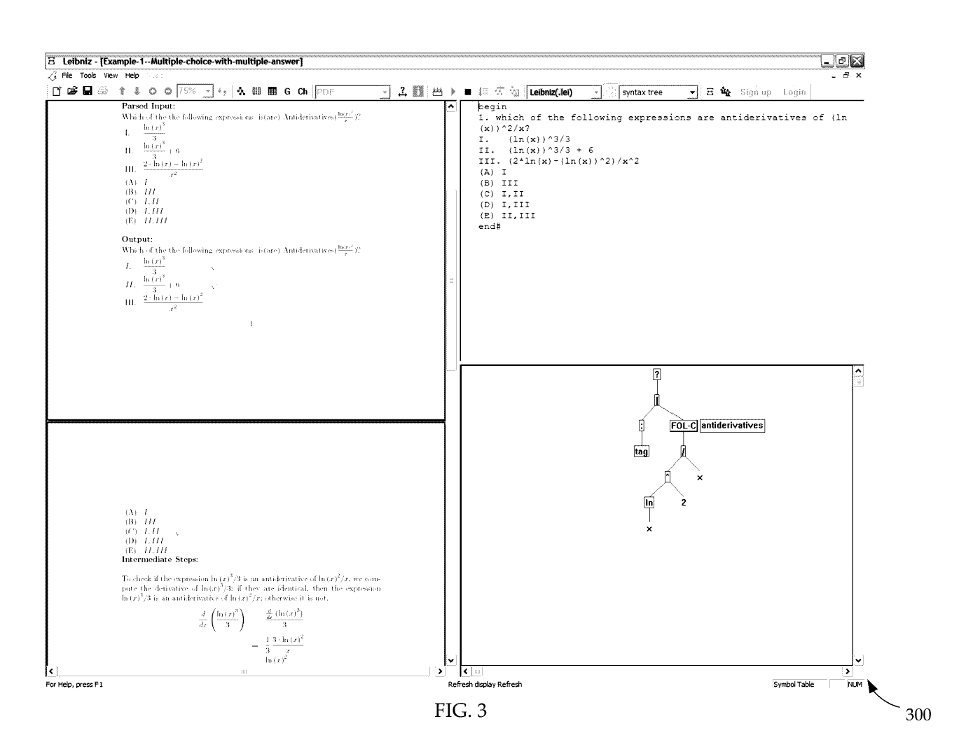

A screenshot 300 showing part of the output for Example 1 is given in FIG. 3. As can be seen from the AST of the engaging query, the subtle subset relationship is represented by the class operator FOL-C that is based on FOL function (symbolized as “FOL-A” in the Leibniz language—a hybrid language that mixes simple English with mathematical expressions that is described in more detail in U.S. Pat. No. 8,943,113, which is incorporated herein by reference in its entirety.

The second type is Dangling Equate. Namely, the stem is ended with a dangling relation terminated with a relation operator such as an “identity” operator. An example (Example 2) is given below.
2. $(1/(1−x)̂2)dx@(2<=x<=3)=
(A) − 3/2
(B) −½
(C) ½
(D) 3/2
(E) 0

Another example (Example 3) of this type is also given here:
3. if function f is defined by f(x)=(sin(3−x))̂2, then (d/dx)f(x)@(x=0)=
(A) 2 cos(3)
(B) −2 sin(3)cos(3)
(C) 2 sin(3)cos(3)
(D) 6 cos(3)
(E) 6 sin(3)cos(3)
   As can be seen, this example uses the substitution operator (@) that is discussed earlier to represent a first-order-derivative evaluated at a specified value of the independent variable.

Yet another example (Example 4) of this type is given below:
4. function f is defined by f(x)=x̂3; if the average value of f on the closed interval
[0,k] is 9, then k=
(A) 3
(B) sqrt(3)
(C) 18̂(⅓)
(D) 36̂(¼)
(E) 36̂(⅓)

As can be seen, this example is slightly more complex than the previous ones that belong to the same category; Rather than a single independent dangling relation as the engaging statement, the engaging statement of this example is the <consequent> part of an implication. Further more, there is another statement before the implication.

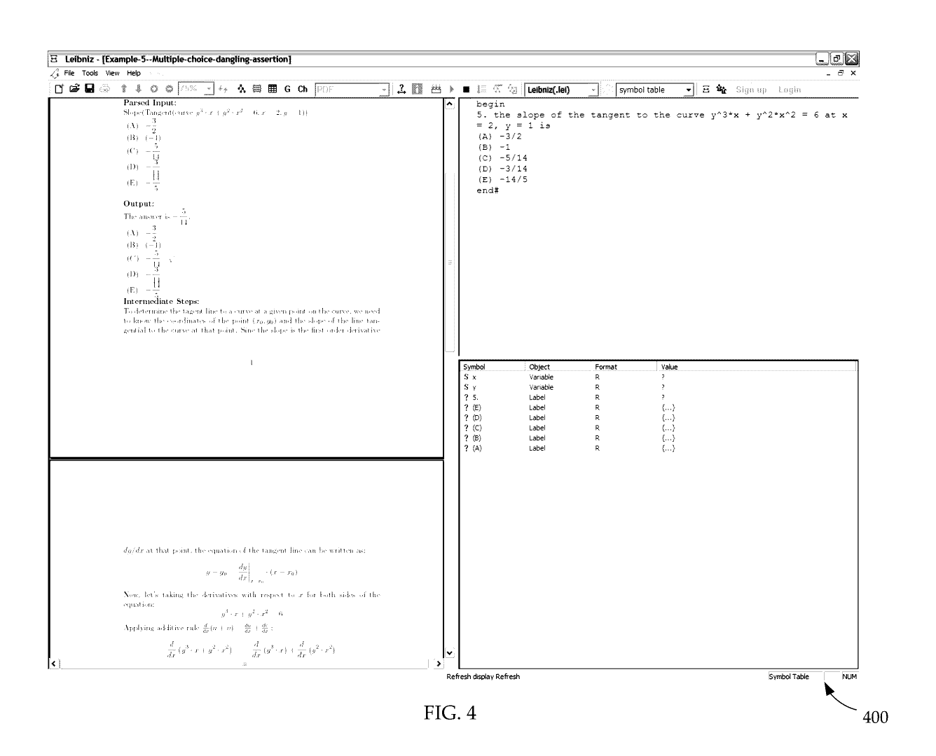

The third type is Dangling Assertion. It is structurally similar to type 2 except now the engaging statement is ended with word “be”¹. An example (Example 5) is given below. Can be “is” or “are” and can be semantically annotated by adding modals and/or negating such as “would (not) be”, “could (not) be”, “be not,” etc.
5. the slope of the tangent to the curve ŷ3*x +ŷ2*x̂2=6 at x=2, y=1 is
(A) − 3/2
(B) −1
(C) − 5/14
(D) − 3/14
(E) − 14/5
   Notice that nested FOL functions are used to represent the engaging assertion. Screenshot of the output for this example is given in FIG. 4.

An important characteristics of this type of multiple-choices problems is that its options may NOT be structurally homogeneous, which is required by the Dangling Equate type (the options must be expressions such that they can join the “=” operator to form equations); due to the flexibility of “be” on its following constituent, the option can be expressions or adjective phrases such as “positive”, “monotonically increasing.”

### Definition of Free-Response Problems

The syntax of free-response problems is actually simpler since it structurally only has one part—call it stem if you'd like. The problem is normally ended with one or more commands or queries. Similarly, the solving process is conceptually simpler since it does not need the option-matching procedure that is required for solving multiple-choice problems.

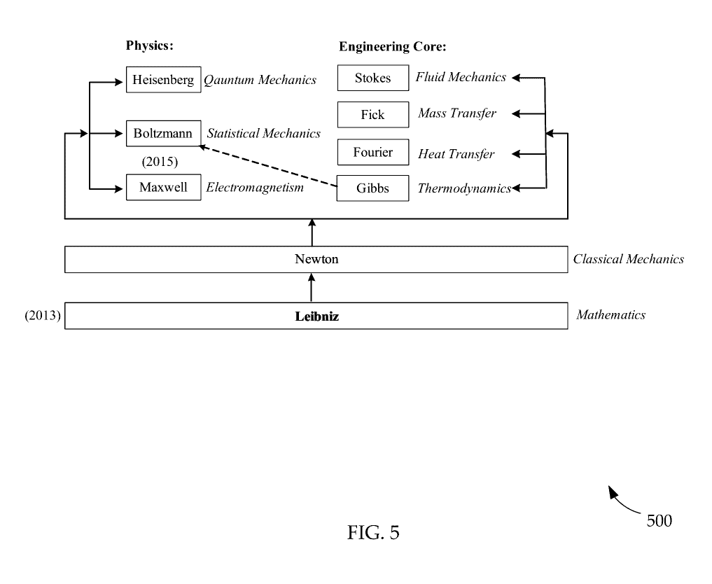

Listed below is an example of defining free-response problems with Leibniz. The example is actually in the domain of electromagnetism and the particular problem is one of U. Chicago's PhD qualification exams in Physics. Leibniz interpreter is able to parse the problem successfully upon the Lexicon is expanded to include “charge”, “current”, and adjective “electric”, etc. That is a initial test of our long-term plan to build learning service systems (LSS) that cover physics including statistical mechanics, quantum mechanics, E&M, and classical mechanics, as well as engineering core subjects including fluid mechanics, heat transfer, mass transfer, and thermodynamics (see FIG. 5). Maxwell's approach is building a domain language for each subject on top of the common mathematical language (Leibniz), with expanded lexicon and knowledge base specific for each individual domain.
6. a static charge distribution (rho) produces a radial electric field

E=E_0*(exp(−kappa*r)/r)*r̂̂;
where E_0,kappa are constant;
(a) compute rho;
(b) what is the total charge Q?
   Notice that subordinating conjunction “where” serves as a statement connective, and the expression is separated from the tag “electric field” through an new line, which are actually specified in the grammar as an acceptable option, although such typesetting is purely for guiding the eyes. Also notice that the word “constant” in the above example is recognized as an adjective.

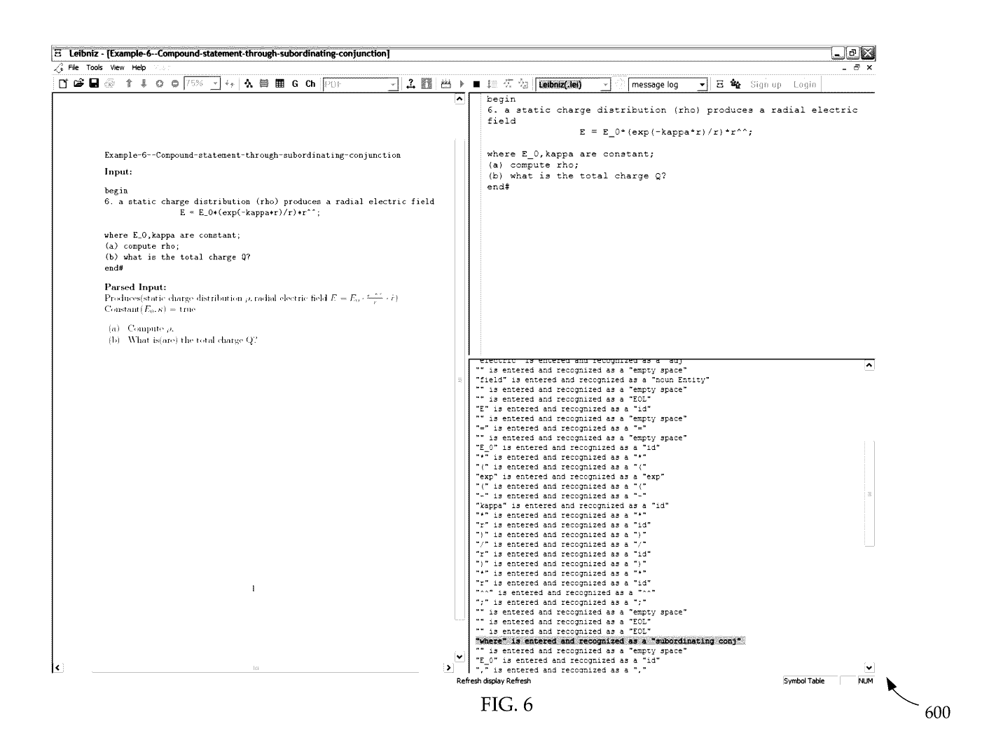

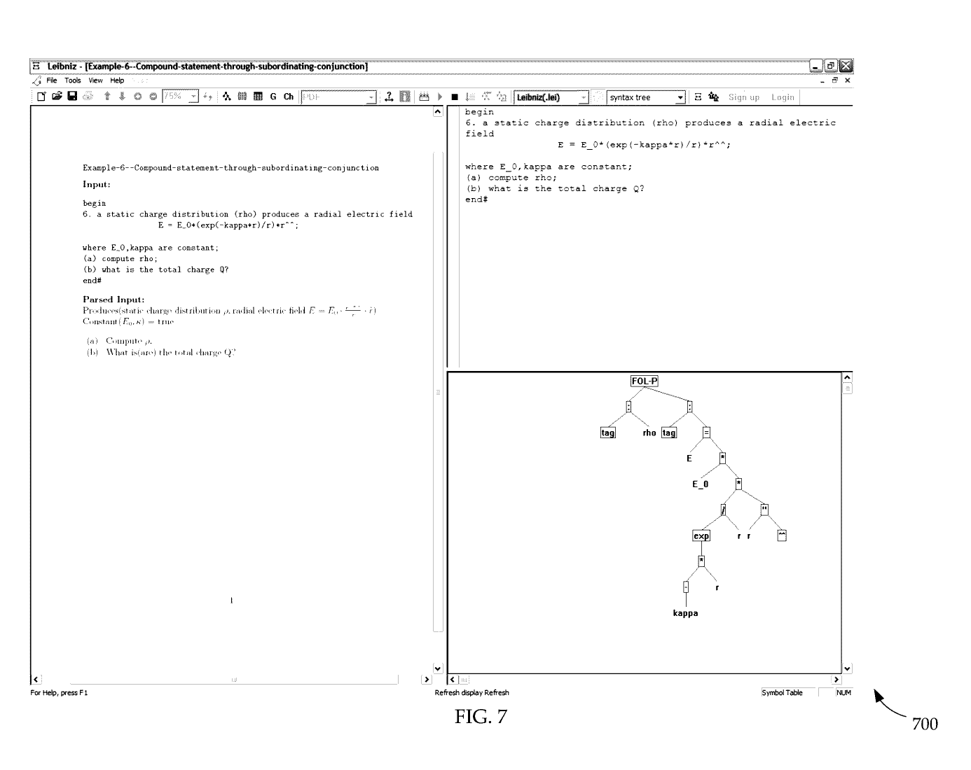

Screenshots from this example are presented in FIG. 6 and FIG. 7.

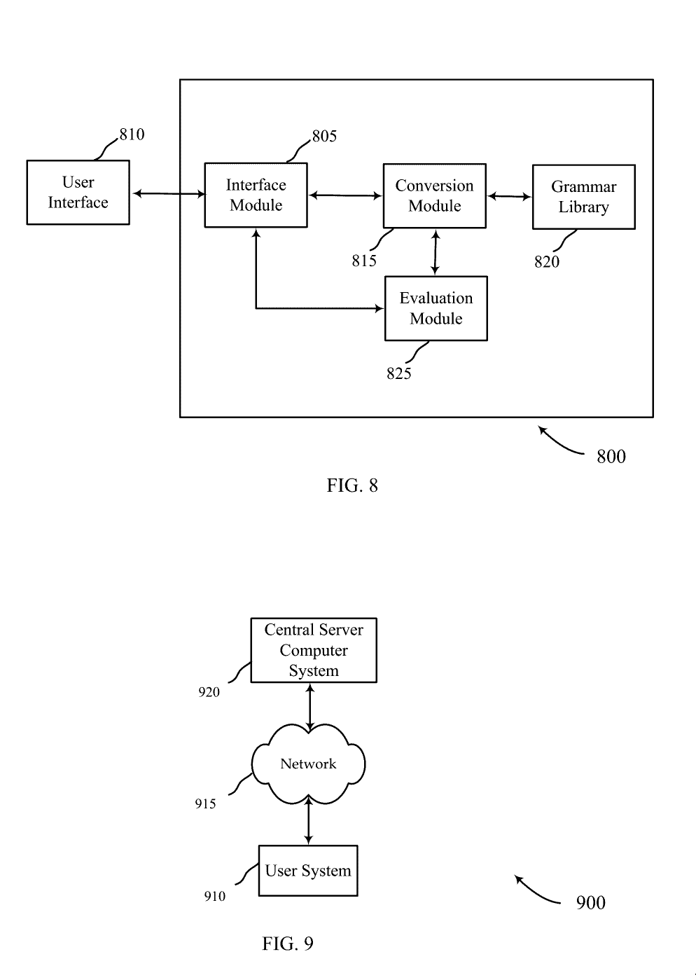

The above examples provide a number of exemplary inputs, outputs, and intermediate steps that may be displayed according to methods and systems of the present disclosure. With reference now to FIG. 8, an exemplary system 800 of an embodiment is described. The system includes an interface module 805, that may provide an interface between a user interface 810 and one or more other modules. The interface module 805 may include one or more communications interfaces on a computer system, for example, that interact with one or more of a monitor, keyboard, and/or mouse of user interface 810. A conversion module 815 is communicatively coupled to the interface module, and functions to convert received input into mathematical expressions and one or more ASTs. In order to perform conversion, the conversion module 815 accesses a grammar library 820, and evaluates received input relative to the grammar library to perform conversion functions. An evaluation module 825 evaluates the ASTs according to functions determined by the conversion module, and outputs results to the interface module 805. As mentioned above, the evaluation may be performed in intermediate steps, with the results of one or more intermediate steps output as well. In other embodiments, various functions of the interface module 805, conversion module 815, grammar library 820, and evaluation module 825 may be performed on a local system, or on a remote system connected to a local system through a network. Such a system 900 is illustrated in FIG. 9. In the embodiment of FIG. 9, a user system 910 is connected through a network 915 to a central server computer system 920, that may perform some or all of the functions described above. The network 915 may a local or wide area network, such as the Internet. The user system 910 may include any of a number of user devices, such as a personal computer, tablet computer, handheld device, or other mobile device as are well known. FIGS. 11 and 12 illustrate screen shots of exemplary outputs that may be provided to a user of such systems.

The detailed description set forth above in connection with the appended drawings describes exemplary implementations and does not represent the only examples that may be implemented or that are within the scope of the claims. The term “exemplary” used throughout this description means “serving as an example, instance, or illustration,” and not “preferred” or “advantageous over other embodiments.” The detailed description includes specific details for the purpose of providing an understanding of the described techniques. These techniques, however, may be practiced without these specific details. In some instances, well-known structures and devices are shown in block diagram form in order to avoid obscuring the concepts as described.

The various illustrative blocks and modules described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and blue-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the spirit or scope of the disclosure.

Thus, the disclosure is not to be limited to the examples and designs described herein but is to be accorded the widest scope consistent with the principles and novel features disclosed herein.

1. A method for receiving and evaluating mathematical statements, comprising:
receiving, at an interface module in a computer system, one or more multiple choice mathematical statements including hybrid statements mixing mathematical expressions and natural language;
converting, via at least one call to a grammar library stored in a memory of the computer system, portions of the one or more multiple choice mathematical statements into a plurality of mathematical expressions and one or more abstract syntax tree (AST) connecting the expressions, wherein the grammar library comprises a set syntax and a tag syntax that enable such converting;
evaluating the mathematical expressions and performing operations on the expressions for each of the converted portions of the one or more multiple choice mathematical statements in accordance with the AST; and
performing at least one of storing a result of the evaluation in the memory or transmitting result of the evaluation to the interface module.

2. The method of claim 1, wherein the one or more multiple choice statements comprise ASCII character representations of a plurality of multiple choice expressions linked together through ASCII character representations of one or more operators.

3. The method of claim 1, wherein the set syntax comprises a plurality of set operators associated with a subset, a subset or equal, a superset, a superset or equal, an intersection, a union, a difference, or a Cartesian product.

4. The method of claim 3, wherein the plurality of set operators comprise ASCII characters.

5. The method of claim 1, wherein the tax syntax is used to describe an intended interpretation for the mathematical expressions.

6. The method of claim 1, wherein the converting comprises converting one or more syntactic structures used in forming one or more compound statements.

7. The method of claim 6, wherein the compound statements comprise one or more of a single word or operator joining two statements; a phrase structure with a comma separating two statements; or a single word or phrase inserted after a delimited statement with sentence-ending punctuation.
